(19) United States
(12) Patent Application Publication
(10) Pub. No.: US 2013/0042874 A1
(43) Pub. Date: Feb. 21, 2013

(54) KYPHOPAD AND METHODS THEREOF

(71) Applicant: Rebecca Gordon, Duvall, WA (US)

(72) Inventor: Rebecca Gordon, Duvall, WA (US)

(21) Appl. No.: 13/214,008

(22) Filed: Aug. 19, 2011

(51) Int. Cl. A61G 15/00

(52) U.S. Cl. 128/845

(57) ABSTRACT

Generally described, the present disclosure relates to medical devices. More specifically, this disclosure relates to a kyphopad and methods thereof. In one illustrative embodiment, the kyphopad can provide support for the area of the body that actually receives pressure. The device can include a first concave-shaped recess receiving a lumber portion of the patient and a second concave-shaped recess receiving a thoracic and cervical portion of the patient allowing medical imaging of a head and spine. The device can be made of radio-translucent material such that the entire kyphopad can be placed within a medical imaging device. In one embodiment, the kyphopad can be adjusted through at least one pad for thoracic spine exams or lumbar spine exams.

### TECHNICAL FIELD

This disclosure generally relates to medical devices, and more particularly, to a kyphopad allowing a patient to be positioned for medical imaging.

### BACKGROUND

Kyphosis is a condition in which the top of the back is excessively curved and appears more rounded than normal. While some degree of curvature is normal, a curve of more than forty (40) degrees can be considered a sign of kyphosis. Kyphosis does not usually cause any symptoms other than the back appearing slouched or hunched. Often kyphosis can cause back pain, stiffness and tiredness. More severe cases, however, require surgery to correct the spine.

Causes of kyphosis can include bad posture or a structural problem with the spine. Postural kyphosis can develop during teenage years due to poor posture, such as slouching, which affects the normal development of the spine. Scheuermann's kyphosis can also develop during the teenage years. For reasons that are still unclear, the vertebrae that make up the spine do not develop in the way they should, and the back takes on a curved appearance. A less common type of kyphosis is congenital kyphosis, which is when the spine does not develop normally in the womb. Kyphosis can also develop later on in life as the result of an underlying condition, such as osteoporosis (weakening of the bones).

Kyphosis can be diagnosed by general practitioners who can examine the spine for any irregularities through simply hand techniques. Other procedures for examining the spine include x-ray, magnetic resonance imaging (MRI), computed tomography (CT), fluoroscopy, ultrasound and the like. Body positioning is important in obtaining specific planar views in imaging the head and spine. By correctly positioning the spine, an overall impression of the spine can be developed. Imaging is used to demonstrate the range of movement of the spine, the intervertebral foramen, facet joints and disc sizes and shape. The head and spine can be imaged in any plane to provide detailed information of soft tissue and bone detail, effective in the diagnosis of disc herniation, facet joint disease, osteoarthritis, disc bulges and nerve root entrapment.

Imaging of certain spinal defects, such as curvatures of the spine, is difficult due to the patient aperture space available in many imaging devices. For example, an MRI device can have a tunnel opening that is only twenty-two (22) inches across. Because a patient having kyphosis is unable to straighten their neck to a normal position when lying on their back, current imaging techniques cannot be used. Furthermore, medical imaging of the head or spine requires that a patient remain motionless in a specific position during the imaging for up to an hour.

U.S. Pat. No. 6,725,481 to Marshall titled “Body Positioner” describes a device for positioning a patient for medical imaging. The device includes a concave-shaped recess for supporting a patient's torso at a low end segment and legs at a high end. The low end and high end of the inclined surface form an obtuse angle with respect to each other. The device described in the Marshall Patent does not provide head support nor does it support the upper torso. The concave-shaped recess does not fully capture the support required in kyphosis patients. Furthermore, the device does not distribute the body weight of the patient to alleviant stress points on the upper thoracic spine and the cervical spine. A need therefore exists for a kyphopad that overcomes these, as well as other related, challenges.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a system is provided. The system can include a kyphosis support made of radio-translucent material for holding a body of a patient. The kyphosis support can include a curved upper segment supporting a cervical and thoracic portion of the patient and a convex-shaped segment coupled to the curved upper segment supporting the thoracic portion of the patient. In addition, the kyphosis support can include a concave-shaped segment coupled to the convex-shaped segment supporting a lumbar portion of the patient. The kyphosis support can also include a bottom segment coupled to the concave-shaped segment supporting a lower limb portion of the patient. The system can include at least one pad made of the radio-translucent material for positioning the body of the patient.

In accordance with another aspect of the present disclosure, a device for positioning a patient for medical imaging is provided. The device can include a radio-translucent material having a first concave-shaped recess receiving a lumber portion of the patient and a second concave-shaped recess receiving a thoracic and cervical portion of the patient allowing medical imaging of a head and spine of the patient. The first concave-shaped recess can be positioned higher than the second concave-recess.

In accordance with yet another aspect of the present disclosure, a method of diagnosing spinal conditions of a patient is provided. The method can include providing a kyphosis support pad having a curved upper segment, concave-shaped segment and convex shaped segment. In addition, the method can include positioning an upper portion of the patient upon the curved upper segment of the kyphosis support pad and positioning a lower portion of the patient upon the concave-shaped segment of the kyphosis support pad where an abdominal portion of the patient extends over the convex-shaped segment that is between the curved upper segment and the concave-shaped segment. The method can also include adjusting the kyphosis support pad through placement of at least one pad and imaging a spine of the patient through the kyphosis support pad.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a side view of an exemplary kyphopad in accordance with one or more aspects of the present disclosure;

FIG. 2 is a top perspective view of the exemplary kyphopad of FIG. 1;

FIG. 3 is a top perspective view of another exemplary kyphopad in accordance with one or more aspects of the present disclosure;

FIG. 4 is a side view of another exemplary kyphopad in accordance with one or more aspects of the present disclosure;

FIG. 5 is a side view of the exemplary kyphopad of FIG. 4 positioned at an angle; and

FIG. 6 is a side view of the exemplary kyphopad of FIG. 4 positioned at another angle.

### DESCRIPTION OF THE DISCLOSURE

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Generally described, the present disclosure relates to medical devices. More specifically, this disclosure relates to a kyphopad and methods thereof In one illustrative embodiment, the kyphopad can provide support for the area of the body that actually receives pressure as opposed to the device disclosed in the Marshall Patent. The device can include a first concave-shaped recess receiving a lumber portion of the patient and a second concave-shaped recess receiving a thoracic and cervical portion of the patient allowing medical imaging of a head and spine of the patient. The device can be made of radio-translucent material such that the entire kyphopad can be placed within a medical imaging device. In one embodiment, the kyphopad can be adjusted through at least one pad for thoracic spine exams or lumbar spine exams.

A number of advantages can be offered by the illustrative embodiment described above. The weight of the body, when positioned within the kyphopad, can be distributed to alleviate the stress at certain points especially on the upper thoracic spine and the cervical spine. In addition, the kyphopad can be rotated easily with the position of padding and round underside. Through this, the patient can be tilted from one position to another offering a wide range of exam potentials without ever jarring the patient. Many additional advantages of the present disclosure will become apparent to those skilled in the relevant art as provided for in the following description.

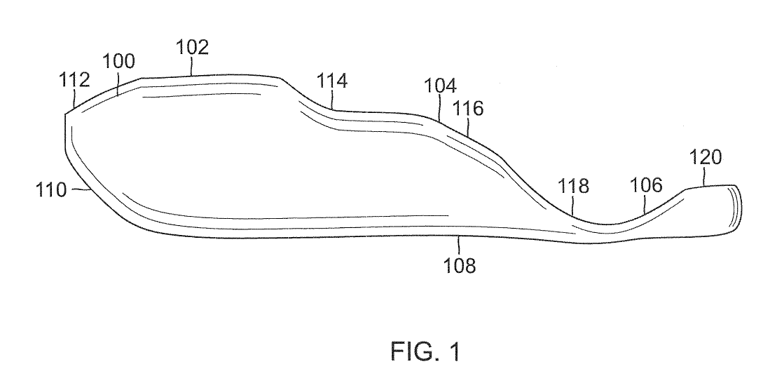

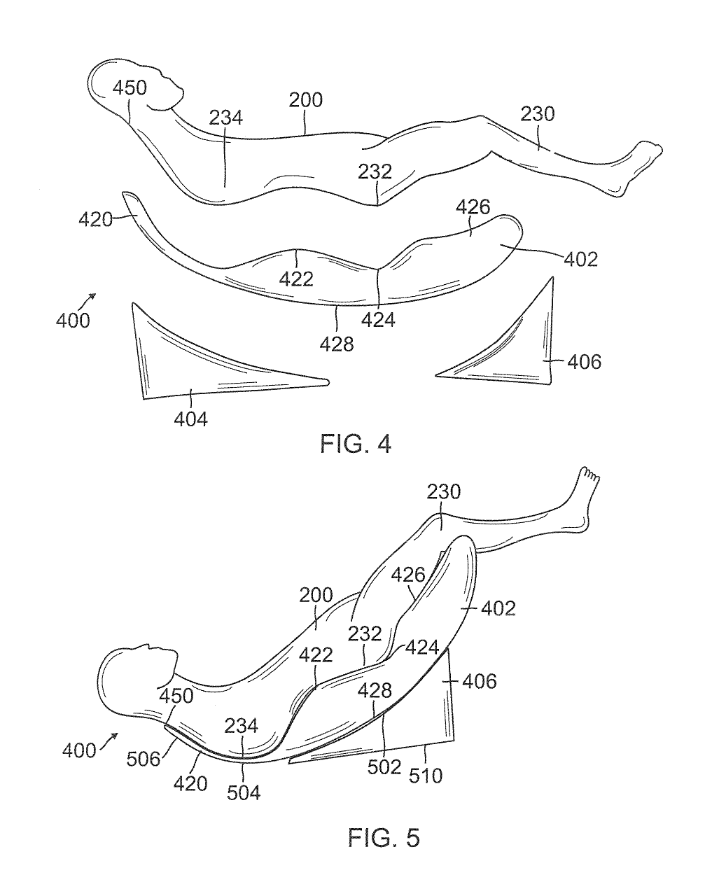

A first kyphopad within the present disclosure will be described in FIGS. 1 through 3. Thereafter, FIGS. 4 through 6 provide another type of kyphopad that can be positioned through insertions of additional padding. For purposes of the present disclosure, the kyphopad can be specifically made for each patient. Alternatively, the kyphopad can be premade and adjusted for each patient through known techniques. Because each patient is unique, numerous curvatures of the back can be accounted for and are within the scope of the present disclosure, even those that do not suffer from kyphosis. The kyphopad, disclosed herein, can be made of radio translucent materials that permit the passage of x-rays or other forms of radiation without affecting the image. Concavity of the kyphopad can refer to a recess, depression or impression, while convexity can refer to a bulge or protrusion within the kyphopad.

Turning to FIG. 1, a side view of an exemplary kyphopad 100 in accordance with one or more aspects of the present disclosure is provided. The kyphopad 100 can have a width proportional to the body of the patient. The width of the kyphopad 100 can also account for the patient's shoulders. The length of the kyphopad 100 can be proportional to the patient's size. Both the width and length of the kyphopad 100 can vary. The kyphopad 100 can be manipulated for anatomical differences between females and males.

The kyphopad 100 can include a top segment 102, middle segment 104 and bottom segment 106. The top segment 102 can be above the middle segment 104 and the middle segment can be above the bottom segment 106. The top segment 102 can be for the lower portion of the patient, while the bottom segment 106 can be for placement of the upper portion of the patient. Each of these segments can vary in length and size and be dependent on the patient. For example, a patient with a bigger torso would have a longer bottom section 106 while a person with short legs would potentially have a smaller top section 102.

The bottom 108 of the kyphopad 100 can have a planar surface. The planar surface 108 can be constructed such that it does not shift or move. The radio translucent material of the kyphopad 100 can have a high coefficient of friction to prevent slippage. The bottom 108 of the kyphopad 100 can also include fasteners to prevent the kyphopad 100 from moving. The fasteners, not shown, can be coupled to the medical imaging device. In one embodiment, the kyphopad 100 can include an inclined back 110. The inclined back 110 can allow a medical professional to position their feet such that they do not agitate the kyphopad 100 when they are helping the patient into the kyphopad 100.

The kyphopad 100 can also incorporate a beveled or chamfered edge 112 near or on the top segment 102. The edge 112 can receive a lower limb portion of the patient. Typically, this includes the legs or feet of the patient. The edge 112 can allow the kyphopad 100 to be inserted into the medical imaging device without any portion of the patient hitting it.

The kyphopad 100 of FIG. 1 can include a concave-shaped recess 114. This indentation 114 can receive a lumber portion of the patient. The indentation 114 can be changed or manipulated depending on the anatomy of the patient. The concave-shaped recess 114 can begin at the top segment 102 and end at the middle segment 104. The curve or bend within the concave-shaped recess 114 can point upwards at an inclined angle.

A second concave-recess 118 can be provided as shown in FIG. 1. The indentation 118 can begin at a middle segment 104 and end at the bottom segment 106. The concave-recess 118 can be positioned lower than the other concave-recess 114. The concave-recess 118 can receive a thoracic and cervical portion of the patient allowing medical imaging of a head and spine of the patient. The shape of the concave-recess 118 can be fitted or pre-made to the patient depending on the curvature of their spine. The concave-recess 118 can curve downwards and point upwards at a small inclined angle.

Between the concave-recesses 114 and 118, can be a convex portion 116. The protrusion 116 can be an intermediary segment and follow closely along the thoracic portion of the patient. This protrusion 116 can prevent slippage of the patient in a downward motion and towards the bottom segment 106.

Shown in FIG. 1, the kyphopad 100 can have a headrest 120. The headrest 120 can provide a flat surface parallel to the surface on which the kyphopad 100 is placed. The headrest 120 can have a shape that maximizes patient comfort. The surface on which the patient is placed can include radio translucent material that holds down a patient such that they do not slip down to the bottom segment 106. Additional padding can be placed on the kyphopad 100 for patient comfort.

Not shown within FIG. 1, a plurality of straps can be incorporated into or on the kyphopad 100. The kyphopad 100 can contain straps on the top segment 102, middle segment 104 and the bottom segment 106 to secure the patient. Other types of fasteners can be used, for example, hook and loop fasteners. The kyphopad 100 of FIG. 1 represents one design. Those skilled in the relevant art will appreciate that there can be a number of different configurations that have fewer or more features than those described above. For example, the inclined back 110 can be removed from the kyphopad 100 and instead, a solid block-shaped structure can be used.

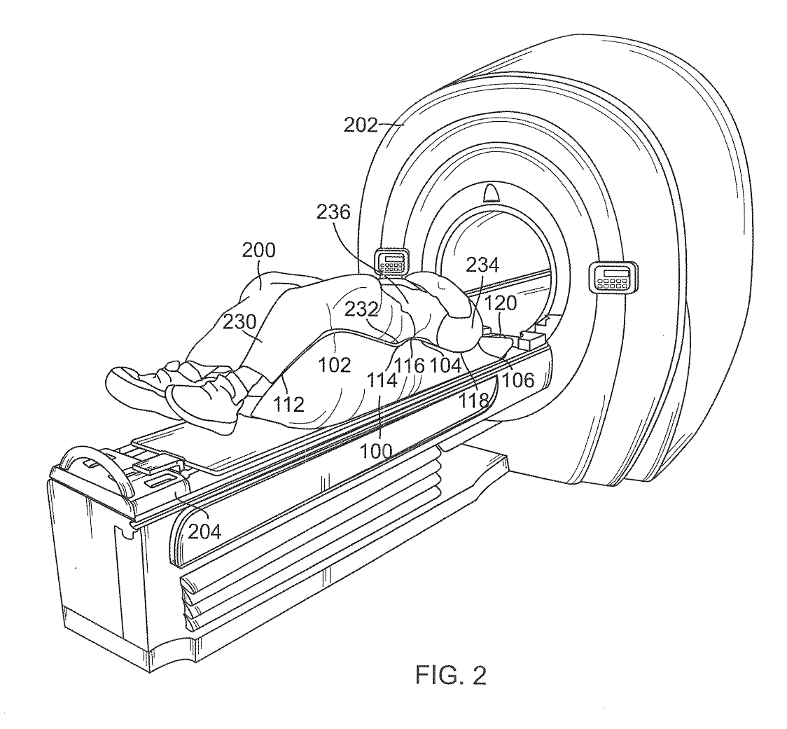

FIG. 2 is a top perspective view of the exemplary kyphopad 100 of FIG. 1. As shown, the body 200 of a patient on top of the kyphopad 100 can be placed on a flat bed 204 of a medical imaging device 202. While the medical imaging device 202 shown is a magnetic resonance imaging (MRI) device, other devices can be used with the kyphopad 100. For example, the kyphopad 100 can be used by patients who are placed in x-ray, computed tomography (CT), fluoroscopy and ultrasound machines.

The body 200 of the patient can be placed over the kyphopad 100 such that their lower extremities 230 are placed on the edge 112. The lower extremities 230 can be angled such that they do not hit the medical imaging device 202 when inserted. The lumbar portion 232 of the spine can be placed within the concave-recess 114. The patient can position their thoracic and cervical portion 234 of their body 200 into the concave-recess 118. Between the concave recesses 114 and 118, the abdominal portion 236 of the patient's body 200 can rest on the convex portion 116.

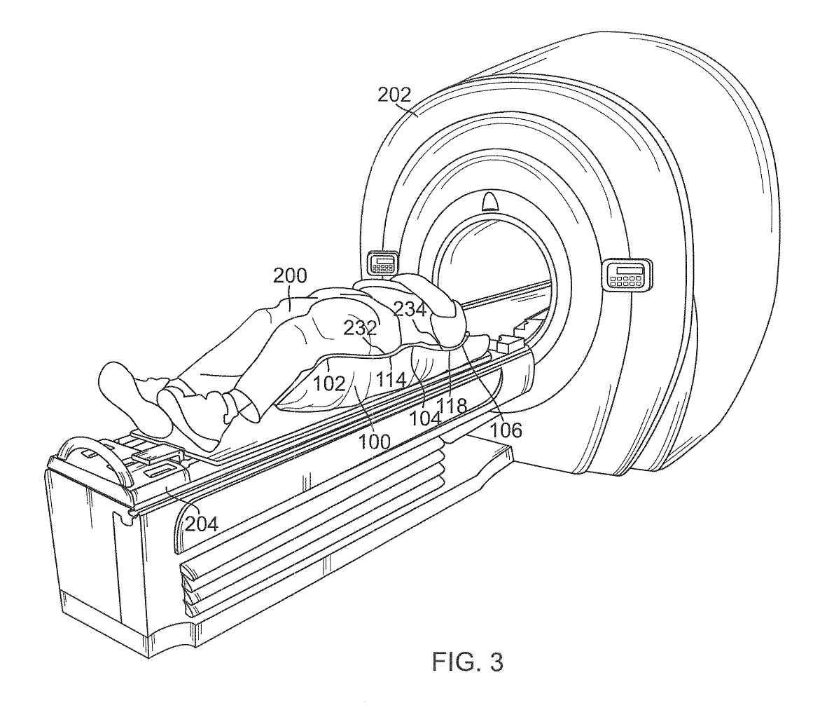

FIG. 3 is a top perspective view of another exemplary kyphopad 100 in accordance with one or more aspects of the present disclosure. The kyphopad 100 can be used by those patients that have less of a curvature than those patients described above. As shown, the differences between the top segment 102, middle segment 104 and bottom segment 106 are not as defined. Nevertheless, the lumbar portion 232 of the body 200 can still be placed within the concave recess 114 and the thoracic and cervical portion 234 can be placed within the concave recess 118. Those skilled in the relevant art will appreciate that a variety of different shapes and forms can be used for the kyphopad 100 and be adjusted dependent on the patient's body 200.

Referring now to FIG. 4, a side view of another exemplary kyphopad 400 in accordance with one or more aspects of the present disclosure is provided. The kyphopad 400 can incorporate a number of different pieces, which can be used to alter the angle or positioning of the patient's body 200. In the shown embodiment, the kyphopad 400 can include a kyphosis support 402 and a plurality of pads 404 and 406. Through the combination of these pieces, the base of the kyphosis support 402 can be easily tilted so that the patient can be given a wide range of exam potentials without ever jarring the patient. The kyphosis support 402 as well as the plurality of pads 404 and 406 can be made of radio-translucent material.

The kyphosis support 402 can include a curved upper segment 420. The curved upper segment 420 can be shaped such that it receives a curvature of the patient's body 200 and in particular, the thoracic and cervical portion 234 of the patient. The curved upper segment 420, in one embodiment, can extend all the way up to the neck and head 450 of the patient. This curved upper segment 420 can prevent the patient from sliding down while still following the shape of a patient who suffers from kyphosis.

A convex-shaped segment 422 can be coupled to the curved upper segment 420. The protrusion 422 of the kyphosis support 402 can support a thoracic portion of the patient. The protrusion 422 can prevent the patient from sliding. The kyphosis support 402 can include a concave-shaped segment 424 coupled to the convex-shaped segment 422. The recess 422 can support a lumbar portion 232 of the patient. A bottom segment 426 coupled to the concave-shaped segment 424 can support the lower limbs 230 of the patient. The bottom segment 426 can be shaped to fit the patient's thighs for a more comfortable fit.

The kyphosis support 402 of the kyphopad 400 can have a width proportional to the body 200 of the patient. The length of the kyphosis support 402 can vary depending on the size of the patient. The kyphosis support 402 can also be manipulated for anatomical differences between females and males.

Continuing with FIG. 4, the bottom 428 of the kyphosis support 402 can be rounded or curved. The angle at which the kyphosis support 402 is curved can depend on the angle or bend of the body 200. This can be customized to the patient or premade and then adjusted. A plurality of pads 404 and 406 can be used for positioning the kyphosis support 402 and the body 200. More than two pads can be used for positioning the kyphosis support 402. Both pads 404 and 406 generally have a rounded top portion to fit with the kyphosis support 402. The kyphosis support 402, the pads 404 and 406 or both can have fasteners so that they can be coupled to one another. These fasteners can include hook and loop fasteners or the like. The pads 404 and 406 can be easily taken out or inserted in to adjust the angle of the kyphosis support 402. Depending on the pads 404 and 406 placed therein, different scans can be performed.

FIG. 5 is a side view of the exemplary kyphopad 400 of FIG. 4 positioned at an angle. A pad 406 can be coupled with the kyphosis support 402 through fasteners. In one embodiment, the friction caused between the bottom 428 of the kyphosis support 402 and the top 502 of the pad 406 can prevent the assembly from breaking and the patient from sliding downwards. The pad 406 can provide a bottom surface 510 preventing slippage. The rounded top section 502 of the pad 406 can conform to the bottom curve 428 of the kyphosis support 402.

The bottom 428 of the kyphosis support 402 can provide a more planar surface such that when positioned, the bottom 428 of the curved upper segment 420 is not rounded and can securely hold the patient in place. As shown, there can be two planar portions 504 and 506. One planer portion 504 can be used to make contact with the surface on which the kyphopad 400 is placed on. The planer portion 504 can provide friction such that the kyphosis support 402 does not slip. Another planar portion 506 coupled to the planar portion 504 can prop a neck and head portion 450 of the patient for medical imaging. In one embodiment, the planer portion 506 can be extended to allow the head of the patient to rest.

The curved upper segment 420 can support the thoracic and cervical portion 234 of the spine. The convex-shaped segment 422 can support the body 200 and prevent the patient from sliding downwards. The lumbar portion 232 of the body 200 can be supported by the concave-shaped segment 424 of the kyphosis support 402. The bottom portion 230 of the patient can be supported by the bottom segment 426. A number of different angles can be supported through the pad 406 and the kyphosis support 402.

In one embodiment, the positioning of the patient's body 200 shown in FIG. 5 can allow for thoracic spine exams. The pad 406 can be placed at the rounded bottom portion 428 of the kyphosis support 402 where the convex-shaped segment 422 and the concave-shaped segment 424 supports the patient. One skilled in the relevant art will appreciate that the pad 406 can be adjusted along the bottom 428 of the kyphosis support 402 to provide different angles at which images can be taken.

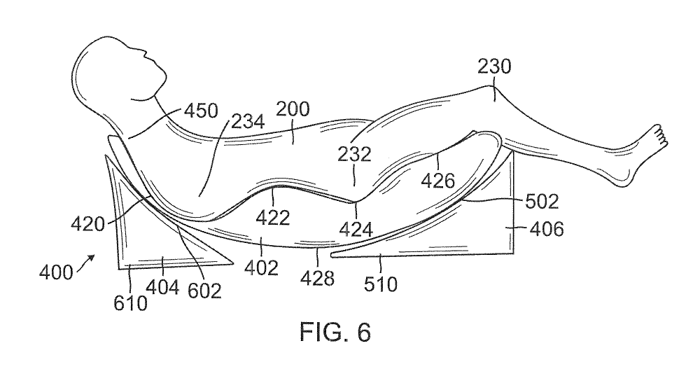

Referring to FIG. 6, a side view of the exemplary kyphopad 400 of FIG. 4 positioned at another angle is provided. In the shown embodiment, both pads 404 and 406 can be used. Each of the pads 404 and 406 can have bottoms 610 and 510 that prevent the kyphosis support 402 from slipping. In one embodiment, the friction caused between the bottom 428 of the kyphosis support 402 and the tops 502 and 602 of the pads 406 and 404 can prevent the assembly from breaking and the patient from sliding downwards. The rounded top sections 502 and 602 can conform to the bottom curve 428 of the kyphosis support 402. Alternatively, the top 602 of the pad 404 can have a planar surface while the top 502 of the pad 406 can have a more rounded surface as shown.

The curved upper segment 420 can support the thoracic and cervical portion 234 of the spine. It also can support the neck and head 450 of the patient. The convex-shaped segment 422 can support the thoracic portion of the body 200. The lumbar portion 232 of the body 200 can be supported by the concave-shaped segment 424 of the kyphosis support 402. The bottom portion 230 of the patient can be supported by the bottom segment 426.

In one embodiment, the positioning of the patient's body 200 shown in FIG. 6 can allow for lumbar spine exams. The first pad 404 can be positioned at the rounded bottom portion 428 of the kyphosis support 402 where the curved upper segment 420 supports the patient. The second pad 406 can be positioned at the rounded bottom portion 428 where the concave-shaped segment 424 and the bottom segment 426 supports the patient. One skilled in the relevant art will appreciate that the pads 404 and 406 can be adjusted along the bottom portion 428 of the kyphosis support 402 to provide different angles at which images can be taken.

While numerous embodiments and implementations have been described above, those skilled in the relevant art will appreciate that fewer or more features can be part of the kyphopads 100 and 400. In one embodiment, additional knee support pads can be provided as well as head support pads. These pads can provide neck and shoulder support while elevating the rest of the body 200 to meet the angle required.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A system comprising:
a kyphosis support made of radio-translucent material for holding a body of a patient, wherein said kyphosis support comprises:
a curved upper segment supporting a cervical and thoracic portion of said patient;
a convex-shaped segment coupled to said curved upper segment supporting said thoracic portion of said patient;
a concave-shaped segment coupled to said convex-shaped segment supporting a lumbar portion of said patient;
a bottom segment coupled to said concave-shaped segment supporting a lower limb portion of said patient; and
at least one pad made of said radio-translucent material for positioning said body of said patient.

2. The system of claim 1, wherein said curved upper segment is thinner than other segments of said kyphosis support.

3. The system of claim 1, wherein said kyphosis support comprises a rounded bottom portion.

4. The system of claim 3, wherein said at least one pad comprises a curved top portion fitting said rounded bottom portion of said kyphosis support.

5. The system of claim 3, comprising a single pad positioned at said rounded bottom portion where said convex-shaped segment and said concave-shaped segment supports said patient for a thoracic spine exam.

6. The system of claim 3, comprising a first pad positioned at said rounded bottom portion where said curved upper segment supports said patient and a second pad positioned at said rounded bottom portion where said concave-shaped segment and said bottom segment supports said patient for a lumbar spine exam.

7. The system of claim 6, wherein said first pad has a planar surface for contacting said rounded bottom portion and said second pad has a curved surface for contacting said rounded bottom portion.

8. The system of claim 1, wherein said kyphosis support comprises fasteners for securing said patient.

9. The system of claim 1, wherein said at least one pad comprises fasteners for securing said kyphosis support.

10. A device for positioning a patient for medical imaging comprising:
a radio-translucent material having a first concave-shaped recess receiving a lumber portion of said patient and a second concave-shaped recess receiving a thoracic and cervical portion of said patient allowing medical imaging of a head and spine of said patient, said first concave-shaped recess positioned higher than said second concave-recess.

11. The device of claim 10, wherein said device comprises a top segment, middle segment and bottom segment, said first concave-shaped recess positioned between said top segment and said middle segment and said second concave-shaped recess positioned between said middle segment and said bottom segment.

12. The device of claim 10, comprising a beveled section receiving a lower limb portion of said patient.

13. The device of claim 10, wherein said first concave-shaped recess leads directly into said second concave-shaped recess.

14. The device of claim 10, wherein said second concave-shaped recess comprises a head rest.

15. The device of claim 14, wherein said head rest is parallel to a surface on which said device is laying on.

16. A method of diagnosing spinal conditions of a patient comprising:
providing a kyphosis support pad having a curved upper segment, concave-shaped segment and convex shaped segment;
positioning an upper portion of said patient upon said curved upper segment of said kyphosis support pad;
positioning a lower portion of said patient upon said concave-shaped segment of said kyphosis support pad where an abdominal portion of said patient extends over said convex-shaped segment that is between said curved upper segment and said concave-shaped segment;
adjusting said kyphosis support pad through placement of at least one pad; and
imaging a spine of said patient through said kyphosis support pad.

17. The method of claim 16, wherein adjusting said kyphosis support pad through placement of said at least one pad comprises inserting a pad under said kyphosis support pad propping said lower portion of said patient up.

18. The method of claim 16, wherein adjusting said kyphosis support pad through placement of said at least one pad comprises inserting a first pad under said kyphosis support pad propping said lower portion of said patient up and inserting a second pad under said kyphosis support pad propping said upper portion of said patient up.

19. The method of claim 16, wherein imaging said spine of said patient through said kyphosis support pad comprises placing said patient on said kyphosis support pad into a medical imaging device.

20. The method of claim 19, comprising fastening said patient on said kyphosis support pad.
